(19) United States
(12) Patent Application Publication
(10) Pub. No.: US 2026/0098976 A1
(43) Pub. Date: Apr. 9, 2026

(54) SYSTEMS AND METHODS FOR GENERATING SYNTHETIC SEISMIC ATTRIBUTES FROM WELL LOGS

(71) Applicant: BP Corporation North America Inc., Houston, TX (US)

(72) Inventor: Jingfeng Zhang, Houston, TX (US)

(73) Assignee: BP Corporation North America Inc., Houston, TX (US)

(21) Appl. No.: 19/347,482

(22) Filed: Oct. 1, 2025

Related U.S. Application Data
(60) Provisional application No. 63/703,656, filed on Oct. 4, 2024.

(51) Int. Cl. G01V 1/28; G01V 1/30

(52) U.S. Cl. CPC G01V 1/282; G01V 1/307

(57) ABSTRACT

A computer-implemented method for generating a synthetic seismic attribute includes receiving well log data obtained from a subsurface region, determining, based on the well log data, a plurality of traveltimes of different rock properties observed at irregular intervals of time, determining, based on the well log data and the plurality of traveltimes, a plurality of reflection coefficients at the irregular intervals of time, convolving the plurality of reflection coefficients with a source wavelet to generate a plurality of unique convolved source wavelets, and generating a synthetic seismic attribute associated with the subsurface region using the plurality of convolved source wavelets.

### CROSS REFERENCE TO RELATED APPLICATIONS

This application claims benefit of U.S. provisional patent application No. 63/703,656 filed Oct. 4, 2024, and entitled “Systems and Methods for Generating Seismic Attributes from Well Logs,” which is hereby incorporated herein by reference in its entirety for all purposes.

### BACKGROUND

Geological formations are explored in a variety of ways to gain knowledge about their physical structure, properties, and fluid content. Such insights may be gathered, for example, by carrying out seismic surveys and well log measurements. A seismic survey typically includes generating an image or map of a subsurface region by sending sound energy down into the subsurface and recording the reflected sound energy that returns from the geological layers within the subsurface region. During a seismic survey, an energy source is placed at various locations on or above a surface region (e.g., a subterranean region of the Earth), which may include hydrocarbon deposits. Each time the source is activated, the source generates a seismic (e.g., sound wave) signal that travels downward through the subsurface region, is reflected, and, upon its return, is recorded using one or more receivers disposed on or above the subsurface region. The seismic data recorded by the receivers may then be used to create an image or profile of the corresponding subsurface region.

On the other hand, well logging instruments take measurements related to various physical properties of subsurface regions from within wellbores drilled through these subsurface regions. These instruments, equipped with various sensors and detectors, measure physical properties such as rock density, resistivity, porosity, and sonic velocities. For example, in a sonic logging system, acoustic waves are emitted and their interval transit time through the subsurface region is recorded. The recorded data may be processed and used to produce detailed logs that reflect subsurface conditions. In some instances, synthetic seismic data or synthetic seismograms may be generated from well logs and correlated or aligned with seismic survey data to improve the interpretation of seismic surveys and the accuracy of subsurface models.

### SUMMARY

An embodiment of a computer-implemented method for generating a synthetic seismic attribute comprises (a) receiving well log data obtained from a subsurface region, (b) determining, based on the well log data, a plurality of traveltimes of different rock properties observed at irregular intervals of time, (c) determining, based on the well log data and the plurality of traveltimes, a plurality of reflection coefficients at the irregular intervals of time, (d) convolving the plurality of reflection coefficients with a source wavelet to generate a plurality of convolved source wavelets, and (e) generating a synthetic seismic attribute associated with the subsurface region using the plurality of convolved source wavelets. In some embodiments, the method comprises (f) interpolating the plurality of convolved source wavelets to generate a plurality of interpolated convolved source wavelets at regular intervals of time. In some embodiments, (e) comprises combining the plurality of interpolated convolved source wavelets to generate the synthetic seismic attribute. In certain embodiments, (c) comprises determining at least one of a magnitude or a phase of each of the plurality of reflection coefficients. In certain embodiments, (d) comprises scaling the source wavelet using magnitudes of the plurality of reflection coefficients to generate a plurality of scaled source wavelets. In some embodiments, (d) comprises shifting a peak of the source wavelet along a timescale along which the plurality of reflection coefficients is irregularly distributed to locations of the plurality of reflection coefficients. In some embodiments, the method comprises (f) rotating the plurality of scaled source wavelets using phases of the plurality of reflection coefficients. In certain embodiments, the plurality of traveltimes comprises traveltimes for each of compressional wave velocity, shear wave velocity, and density. In certain embodiments, the source wavelet is unrelated to the subsurface region. In some embodiments, the synthetic seismic attribute comprises a synthetic seismic gather.

An embodiment of a method for generating a synthetic seismic attribute from a well log comprises (a) receiving well log data obtained from a subsurface region, (b) determining a plurality of traveltimes of different seismic signals observed at irregular intervals of time from the well log data, (c) determining, based on the well log data and traveltimes, a plurality of reflection coefficients, (d) convolving the plurality of reflection coefficients with a source wavelet to generate a plurality of convolved source wavelets at the irregular intervals of time, (e) transforming the plurality of convolved source wavelets at the irregular intervals of time into a plurality of synthetic values located at regular intervals of time, and (f) generating, based on the plurality of synthetic values, synthetic data associated with the subsurface region. In some embodiments, the method comprises (g) interpolating the plurality of convolved source wavelets to generate a plurality of interpolated convolved source wavelets at regular intervals of time. In certain embodiments, (f) comprises adding the plurality of interpolated convolved source wavelets to an output grid. In certain embodiments, (c) comprises determining at least one of a magnitude or a phase of each of the plurality of reflection coefficients. In some embodiments, (d) comprises scaling the source wavelet using magnitudes of the plurality of reflection coefficients to generate a plurality of scaled source wavelets. In some embodiments, the method comprises (g) shifting a peak of the source wavelet along a timescale along which the plurality of reflection coefficients is irregularly distributed to locations of the plurality of reflection coefficients. In certain embodiments, the method comprises (g) rotating the plurality of scaled source wavelets using phases of the plurality of reflection coefficients. In certain embodiments, the plurality of traveltimes comprises traveltimes for each of compressional wave velocity, shear wave velocity, and density.

An embodiment of a system comprises one or more processors, and a storage device coupled to the one or more processors, the storage device configured to store instructions that, when executed by the one or more processors, configure the one or more processors to receive well log data obtained from a subsurface region, determine, based on the well log data, a plurality of traveltimes of different rock properties observed at irregular intervals of time, determine, based on the well log data and the plurality of traveltimes, a plurality of reflection coefficients at the irregular intervals of time, convolve the plurality of reflection coefficients with a source wavelet to generate a plurality of convolved source wavelets, and generate a synthetic seismic attribute associated with the subsurface region using the plurality of convolved source wavelets. In some embodiments, the instructions, when executed by the one or more processors, cause the one or more processors to interpolate the plurality of convolved source wavelets to generate a plurality of interpolated convolved source wavelets at regular intervals of time. In some embodiments, the instructions, when executed by the one or more processors, cause the one or more processors to add the plurality of interpolated convolved source wavelets to an output grid. In certain embodiments, the reflection coefficients each comprise at least one of a magnitude or a phase. In certain embodiments, the instructions, when executed by the one or more processors, cause the one or more to scale the source wavelet using magnitudes of the plurality of reflection coefficients to generate a plurality of scaled source wavelets. In some embodiments, the instructions, when executed by the one or more processors, cause the one or more processors to shift a peak of the source wavelet along a timescale along which the plurality of reflection coefficients is irregularly distributed to locations of the plurality of reflection coefficients. In some embodiments, the instructions, when executed by the one or more processors, cause the one or more processors to rotate the plurality of scaled source wavelets using phases of the plurality of reflection coefficients.

### BRIEF DESCRIPTION OF THE DRAWINGS

Various aspects of this disclosure may be better understood upon reading the following detailed description and upon reference to the drawings in which:

FIG. 1 is a flowchart of various processes that may be performed based on analysis of seismic data in accordance with principles disclosed herein;

FIG. 2 is a schematic view of an embodiment of a well logging system in accordance with principles disclosed herein;

FIG. 3 is an exemplary computer system that may perform operations described herein based on data acquired via the well logging system of FIG. 2 in accordance with principles disclosed herein;

FIG. 4 is a graphical representation illustrating a comparison between original well log measurements and interpolated well log using a fixed time interval in accordance with principles disclosed herein;

FIGS. 5 and 6 are graphical representations illustrating examples of seismic data obtained from the same well log but generating different synthetic data in accordance with principles disclosed herein;

FIG. 7 is a flowchart illustrating operation of a method for generating synthetic data from well logs in accordance with principles disclosed herein;

FIG. 8 is a diagram illustrating the determination of reflection coefficients in accordance with principles disclosed herein;

FIGS. 9a and 9b are diagrams illustrating convolution of the reflection coefficients with a source wavelet in accordance with principles disclosed herein;

FIG. 10 is a graphical representation illustrating examples of synthetic attributes obtained using the flowchart of FIG. 7 in accordance with principles disclosed herein;

FIG. 11 is a graphical representation illustrating a comparison of synthetic attributes generated using the flowchart of FIG. 7 with synthetic attributes generated using conventional methods in accordance with principles disclosed herein;

FIG. 12 is a flow diagram of an embodiment of a method for generating synthetic attributes from well logs in accordance with principles disclosed herein; and

FIG. 13 is a flow diagram of another embodiment of a method for generating synthetic attributes from well logs in accordance with principles disclosed herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

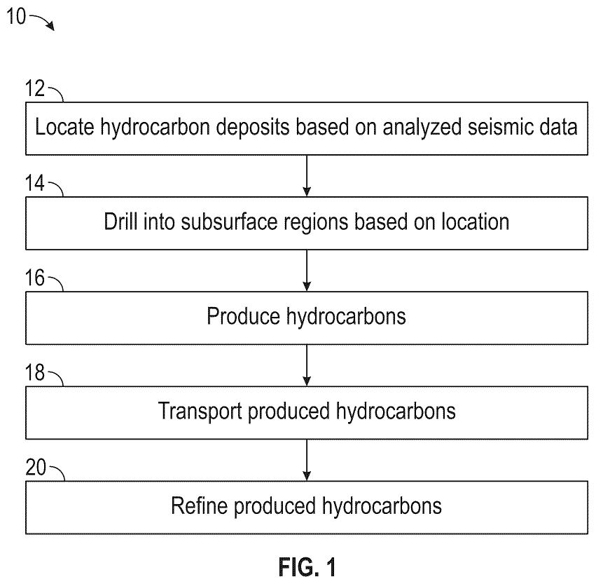

By way of introduction, seismic data may be acquired using a variety of seismic systems and techniques. Regardless of the seismic data gathering technique utilized, after the seismic data is acquired, a computer system may analyze the acquired seismic data and may use the results of the seismic data analysis (e.g., seismogram, map of geological formations, etc.) to perform various operations within the hydrocarbon exploration and production industries. For instance, FIG. 1 illustrates a flow diagram of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region (e.g., a subterranean region of the Earth) associated with the respective seismic data may be determined based on the analyzed seismic data. For example, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to for example, determine locations at the surface of the subsurface region to drill into the subsurface region. As such, the hydrocarbon exploration organizations may use the locations and properties of the hydrocarbon deposits and the associated overburdens to determine a path along which to drill into the subsurface region, how to drill into the subsurface region, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic acquisition systems. As such, it should be understood that the processes described above are not intended to depict an exhaustive list of processes that may be performed after determining the locations and properties of hydrocarbon deposits within the subsurface region.

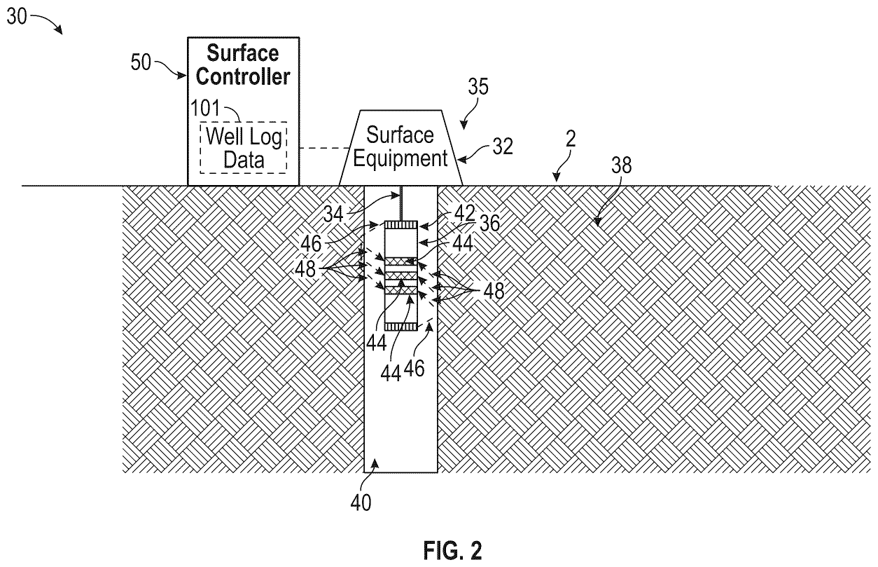

Referring to FIG. 2, an embodiment of a well logging system 30 for collecting well log data 101 is shown. Particularly, well logging system 30 illustrates a logging operation being performed by a downhole logging tool 36 suspended in a wellbore 40 by a deployment system 35. The deployment system 35 comprises surface equipment 32 and wireline 34. Wireline 34 is extendable into and retractable from the wellbore 40 via operation of surface equipment 32 such that wireline 34 may be run into wellbore 40 with the downhole logging tool 36 suspended therefrom. Downhole Logging tool 36 may include one or more well logging instruments for collecting well log data 101. For example, downhole logging tool 36 may comprise a sonic logging tool, or a sonic logging tool combined with other types of well logging instruments (e.g., a density logging tool). Downhole Logging tool 36 may have an explosive, a radioactive, electrical, or acoustic energy source configured to emit a transmission signal, and one or more sensors or receivers that sends and/or receive electrical signals to/from subsurface region 38 and fluids therein surrounding wellbore 40. Although well logging system 30 generally includes downhole logging tool 36 deployed on wireline 34, it is understood that other suitable deployment members or strings including, for example, slickline, tubing, coiled tubing, or drill pipe, may also be used depending on the specific application. Additionally, wellbore 40 may be formed with various dimensions (e.g., diameter, depth). It may also be understood that wellbore 40 is formed using a drilling system not shown in FIG. 2 which may include, among other things, a support structure (e.g., a derrick, a mast) located at the surface 2, and a drilling assembly deployable into the subsurface region 38 including a drill bit for cutting into the subsurface region 38 and which is coupled to a downhole end of a drill string suspended from the surface support structure.

In this exemplary embodiment, downhole logging tool 36 is in signal communication with a surface controller 50 of well logging system 30. The surface controller 50 may control, monitor, collect, or pre-process well log data 101 generated during the logging operation and collected by downhole logging tool 36. As will be described further herein, well log data 101 may be stored or transmitted for further processing. Downhole logging tool 36 may be transported through wellbore 40 via deployment system 35 whereby downhole logging tool 36 may be positioned at various surface depths in wellbore 40 to provide measurements or other information relating to the subsurface region 38. As used herein, the term “surface depth” refers to the total vertical depth (TVD) from the surface 2 to a subsurface location (e.g., a location in wellbore 40) of interest.

In this exemplary embodiment, downhole logging tool 36 includes a sonic logging tool configured to provide detailed information about the acoustic properties of the subsurface region, which can aid in evaluating characteristics of the subsurface region 38 like porosity, lithology, and fluid content. In some embodiments, the downhole logging tool 36 includes one or more sonic receivers 44 (e.g., an array of sonic receivers 44) and one or more sonic transmitters 42 configured to produce or generate energy in the form of a transmission signal (e.g., sound or sound waves 46 in this exemplary embodiment as indicated in FIG. 2) that is directed into the subsurface region 38 surrounding wellbore 40. The type of sound wave 46 generated by downhole logging tool 36 may include compressional waves (P-waves), shear waves (S-waves), etc. The sound waves 46 produced by sonic transmitters 42 travel into and through the subsurface region 38 surrounding wellbore 40 whereby the sound waves 46 are reflected off of a boundary or other subsurface feature of subsurface region 38 as reflected waves 48 directed towards the downhole logging tool 36. Reflected waves 48 are subsequently detected by the array of sonic receivers 44 that are spaced at known intervals from sonic transmitter 42 thereby, allowing for measurement of the interval transit time for the sound waves 46 and corresponding reflected waves 48 to be estimated. In the context of a downhole logging operation (e.g., facilitated by downhole logging tool 36 and well logging system 30 in this exemplary embodiment), the interval transit time corresponds to the time required for sound waves to travel from a sonic transmitter 42 (e.g., as sound waves 46) from which the sound wave 46 is generated, reflect off of a boundary or other subsurface feature of subsurface region 38, and be received by a corresponding sonic receiver 44 where the sound wave is detected as a reflected wave (e.g., as reflected waves 48). In this manner, the actual or observed interval transit time of sound waves 46/reflected waves 48 may be directly observed for a given surface depth. In some embodiments, the interval transit time may be transmitted via deployment system 35 to the surface 2 where the interval transit times may be recorded as well log data 101 by surface controller 50. Alternatively, the interval transit times observed by downhole logging tool 36 may be recorded into a memory thereof and retrieved later after downhole logging tool 36 has been retracted by deployment system 35 to the surface 2.

Given that interval transit time is a reciprocal of the velocity of the subsurface region 38 at a given surface depth, velocities (e.g., of sonic signals or waves travelling through an interval of surface depth) of the subsurface region 38 at various surface depths may be determined directly from the interval transit times collected in the sonic log. That is, the velocities (e.g., P-wave velocity (Vp) and/or shear wave velocity (Vs)) corresponding to different intervals of surface depth of subsurface region 38.

In some embodiments, given that the distances between sonic transmitters 42 and sonic receivers 44 is known, the recorded interval transit times are used to determine the two-way traveltime (TWT) for sound waves passing through the subsurface region 38 at a given surface depth. For instance, one-way travel time may be estimated by dividing the known distance (e.g., corresponding to the layer of thickness of the subsurface region 38) by the velocity of the subsurface region 38 at a selected surface depth. Additionally, TWT may be determined by multiplying the determined one-way travel time by two to account for the additional time required for the sound wave to return to the surface. Particularly, as used herein, TWT refers to the time required for a seismic wave to travel from a source to a reflector (such as a geological layer of a subsurface region) and back to the receiver. Generally, TWT is twice the one-way traveltime because the sound wave travels to the target and then returns to the surface.

Generally, TWTs estimated for different surface depths may be used to transform well log data 101 from the depth domain (e.g., specific to or a function of surface depth) into the time domain (e.g., as a function of time rather than surface depth) in order to generate one or more synthetic seismic attributes such as synthetic seismograms or synthetic seismic gathers from which the subsurface region 38 may be evaluated. As used herein, the terms “synthetic seismic attribute” and “synthetic seismogram,” refer to seismic data generated by combining well log data (e.g., well log data 101 including Vp, Vs, and/or ρ for different intervals of surface depth of subsurface region 38 along with TWTs estimated for different surface depths of subsurface region 38) with a generic synthetic signal (also referred to as a source wavelet) that is not specific or unrelated (e.g., is agnostic) to a given subsurface region (e.g., subsurface region 38). In other words, a generic source wavelet is transformed by well log data associated with a selected subsurface region into synthetic seismic attribute specific to the selected subsurface region, whereby the synthetic seismic attribute may be used to predict or model how seismic waves would travel through the selected subsurface region. As used herein, the term “synthetic seismic gather” refers to a collection or combination of different synthetic seismic attributes such as, for example, different synthetic seismograms or synthetic seismic traces.

Although well logging system 30 is described above in the context of downhole logging tool 36, in other embodiments, well logging system 30 may include additional equipment providing additional functionalities. For example, in some embodiments, well logging system 30 may also include one or more sensors used to collect data relating to, for example, fluid composition and/or other downhole parameters. Thus, it may be understood that well logging system 30 may include additional features and equipment not shown in FIG. 2, which illustrates well logging system 30 in a simplified form.

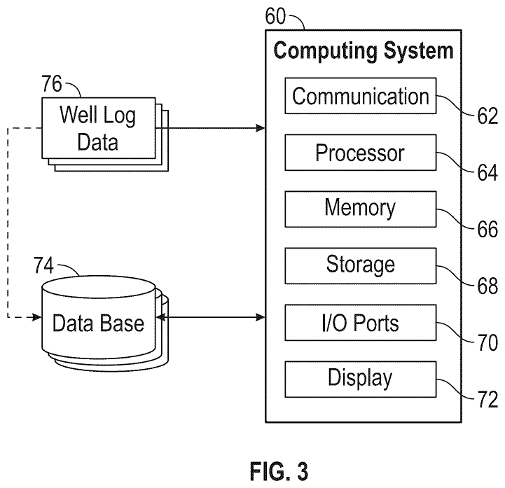

Referring now to FIG. 3, an exemplary computer system 60 that may perform operations described herein based on well log data and/or other information acquired via a well logging system (e.g., well logging system 30 of FIG. 2) is shown. Additionally, in some embodiments, the surface controller 50 shown in FIG. 2 may comprise a computer system similar in configuration or otherwise having features in common with computer system 60 shown in FIG. 3. The computer system 60 may include a communication component 62, a processor 64, memory 66, storage 68, input/output (I/O) ports 70, and a display 72. In some embodiments, the computer system 60 may omit one or more of the display 72, the communication component 62, and/or the input/output (I/O) ports 70. The communication component 62 may be a wireless or wired communication component that may facilitate communication between the well log data 76, one or more databases 74, other computing devices, and/or other communication capable devices. In some embodiments, the computer system 60 may receive well log data 76 (e.g., well log data 101 of FIG. 2) via a network component, the database 74, or the like. The processor 64 of the computer system 60 may analyze or process the well log data 76 to ascertain various features regarding geological formations within the subsurface region 38.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process well log data acquired via receivers of a downhole logging tool (e.g., downhole logging tool 36 of FIG. 2) according to the embodiments described herein. Processor 64 may also process other data such as source wavelets (e.g., generic wavelets) such as by combining or convolving the source wavelet with well log data as will be discussed further herein.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computer system 60 to communicate with the other devices in the well logging system 30, or the like via the I/O ports 70.

The display 72 may depict visualizations associated with software or executable code being processed by the processor 64. In one embodiment, the display 72 may be a touch display capable of receiving inputs from a user of the computer system 60. The display 72 may also be used to view and analyze results of the analysis of the acquired well log data to determine the geological formations within the subsurface region 38, the location and property of hydrocarbon deposits within the subsurface region 38, predictions of properties associated with one or more wells in the subsurface region 38, and the like. The display 72 may be any suitable type of display, such as a liquid crystal display (LCD), plasma display, or an organic light emitting diode (OLED) display, for example. In addition to depicting the visualization described herein via the display 72, it should be noted that the computer system 60 may also depict the visualization via other tangible elements, such as paper (e.g., via printing) and the like.

With the foregoing in mind, the present techniques described herein may also be performed using a supercomputer that employs multiple computer systems 60, a cloud-computer system, or the like to distribute processes to be performed across multiple computer systems 60. In this case, each computer system 60 operating as part of a super computer may not include each component listed as part of the computer system 60. For example, each computer system 60 may not include the display 72 since multiple displays 72 may not be useful to, for example, a supercomputer designed to continuously process seismic data.

After performing various types of well data processing, the computer system 60 may store the results of the analysis in one or more databases 74. The databases 74 may be communicatively coupled to a network that may transmit and receive data to and from the computer system 60 via the communication component 62. In addition, the databases 74 may store information regarding the subsurface region 38, such as previous seismograms, geological sample data, seismic images, and the like regarding the subsurface region 38.

Although the components described above have been discussed with regard to the computer system 60, it should be noted that similar components may make up the computer system 60. Moreover, the computer system 60 may also be part of the well logging system 30, and thus may monitor and control certain operations of the downhole logging tool 36, and the like. Further, it should be noted that the listed components are provided as example components and the embodiments described herein are not to be limited to the components described with reference to FIG. 3.

In some embodiments, the computer system 60 may generate a two-dimensional representation of the subsurface region 38 based on the well log data received via the receivers mentioned above. Additionally, well log data associated with multiple source/receiver combinations may be integrated or combined to create a near continuous profile of the subsurface region 38 that can extend for some distance. In some embodiments, well log data may be integrated with seismic data to create 3D or 4D models of the subsurface region 38.

In any case, a well log or well log data may be composed of a very large number of individual recordings or traces. As such, the computer system 60 may be employed to analyze the acquired well log data to obtain a representation of the subsurface region 38 and to determine locations and properties of hydrocarbon deposits. To that end, a variety of data processing algorithms may be used to remove noise from the acquired well log data, integrate the well log data with data obtained from seismic surveys, and the like.

After the computer system 60 analyzes the acquired well log data, the results of the well data analysis (e.g., seismogram, seismic images, map of geological formations, etc.) may be used to perform various operations within the hydrocarbon exploration and production industries. For instance, as described above, the acquired well log data may be used to perform the method 10 of FIG. 1 that details various processes that may be undertaken based on the analysis of the acquired well log data.

As previously described, seismic data play an important role in the exploration and characterization of subsurface structures such as hydrocarbon reservoirs, geological formations, and for monitoring potential hazards. Seismic data may be derived from seismic surveys or from well logs. Seismic surveys provide large-scale imaging of geological features such as stratigraphic, lithologic, and structural characteristics like faults, folds and stratigraphic layers. For example, a seismic survey system may include one or more seismic sources, one or more receivers, and/or other equipment that may assist in acquiring seismic images representative of geological formations within a subsurface region (e.g., an Earthen or subterranean region extending beneath a terranean surface). The seismic survey may be conducted on a surface above the subsurface region in a land-based survey system, or in an ocean or other body of water over a subsurface region that lies beneath a seafloor. The seismic source(s) may produce energy (e.g., sound waves, seismic waveforms) that is directed at the subsurface region.

Upon reaching various geological formations (e.g., salt domes, faults, folds) within the subsurface region, the energy output by the seismic source(s) may be reflected off of the geological formations and acquired or recorded by one or more receivers. In some embodiments, the seismic data recorded by the receivers may then be used to create an image or profile of the corresponding subsurface region. However seismic images derived from conventional imaging techniques may encounter various challenges that compromise the accuracy and reliability of the resulting images and/or other seismic attributes derived from the seismic data obtained at the surface. For example, seismic survey data may be limited by factors such as resolution, wavelength, and noise. Well log data on the other hand, given that it is collected downhole at different surface depths, may address at least some of the limitations of surface-obtained seismic data described above. However, well log data has its own respective operational challenges (e.g., the sampling rate at which downhole logging tools can collect and record data) that can affect the quality of data (e.g., sonic data) recovered thereby.

Particularly, well log data offers high-resolution measurements of physical properties such as porosity, density, or sonic velocity at different surface depths of a subsurface region, thereby providing detailed insights into subsurface features. As previously described, a well logging operation may be conducted downhole in a wellbore (e.g., wellbore 40 of FIG. 2) drilled through a subsurface region. For example, a well logging system (e.g., well logging system 30 of FIG. 2) may include a logging tool (e.g., downhole logging tool 36 of FIG. 2) and other equipment that may assist in acquiring downhole well log data (e.g., well log data 101 of FIG. 2) representative of a geological formation within a subsurface region (e.g., subsurface region 38 of FIG. 2). The logging tool may comprise for example, a sonic logging tool, a density logging tool (for estimating a density ρ of the subsurface region), and/or other well logging tools. In some embodiments, the logging tool produces energy (e.g., sound or sonic signals or waves) that is directed into the subsurface region surrounding the wellbore. The sound waves travel through the subsurface region surrounding the wellbore and are detected by one or more sonic receivers located along the downhole logging tool. The interval transit times, of the sound waves passing through and reflecting off the subsurface region may be measured and recorded as they are received by the sonic receivers. These interval transit times may be used to determine both velocity and TWT of the subsurface region 38 at various surface depths thereof in order to generate synthetic seismic attributes such as synthetic seismograms which may be correlated or aligned with the broader seismic survey data, thereby improving the interpretation of seismic data.

Conventionally, well log data is sampled downhole repeatedly at different surface depths whereas the parameters of the subsurface region (e.g., Vp, Vs, and ρ of the subsurface region) are presented as a function of time rather than surface depth. Further, synthetic seismic attributes generated from such well log data for reservoir characterization purposes is usually in time. The well log data may include a sonic log having estimates of Vp and/or Vs for different intervals of surface depth of the subsurface region and/or a density log having estimates of ρ for different intervals of surface depth of the subsurface region, where one or more of Vp, Vs, or ρ may be determined using the interval transit times described above.

In order to transform the well log data into regular intervals of time to compare and interpret the well log data alongside the seismic survey data, well logs are conventionally interpolated so that reflection coefficients, which are derived from the well log data (e.g., from a sonic log and/or density log of the well log data) and refer to the ratio of the reflection amplitude to the incident wave amplitude at a given surface depth of a subsurface region. Additionally, using time-depth or time-to-depth conversion, a synthetic seismic gather may be generated using TWTs derived from the recorded interval transit times from well log data to simulate or model how the subsurface region would appear in seismic survey data. In this manner, interval transit times obtained directly from the well log data may be converted to TWTs to create a time-depth relationship specific to each well location, and the resulting data is then compared with seismic survey data to improve the accuracy of subsurface models.

In a traditional time-depth conversion, the reflection coefficients or well log data (e.g., Vp, Vs, and density) (whether in the surface depth or time domains) are interpolated to ultimately provide a set of interpolated reflection coefficients or well log data that are evenly distributed in linear time. For instance, the well log data may be originally determined at geological interfaces present in the subsurface region that is irregularly spaced, thereby requiring interpolation of these original well log data to thereby fill in the gaps with regularly or equidistantly spaced well log data in time, which may be used to generate a continuous synthetic seismic trace. Particularly, the evenly distributed well log data, and the calculated reflection coefficients may be convolved with a synthetic signal or source wavelet to generate a synthetic seismic attribute in the form of a synthetic seismic trace. As used herein, the terms “synthetic signal” and “source wavelet” refer to a predefined signal that is not specific or unrelated to a given subsurface region.

Oftentimes, when interpolating well log data, estimates about rock properties are made based on assumptions, which may not accurately represent actual subsurface conditions. For example, in new areas where direct measurements are not available, estimates based on assumptions may be used, and may introduce artificial boundaries or interfaces between subsurface layers that do not actually exist. Thus, assumptions are not desirable in practice because they can lead to inaccurate interpretation of substance conditions. Additionally, the manner in which the interpolation of the reflection coefficients is performed can ultimately and undesirably affect the accuracy of the synthetic seismic attribute produced therefrom. For instance, the “study window” or choice of interpolation interval (i.e., the distance between interpolated points) can affect the accuracy of the resulting synthetic seismogram. Additionally, and as described further herein, using different interpolation intervals, even when using the same well log data can yield different synthetic seismograms of varying degrees of accuracy.

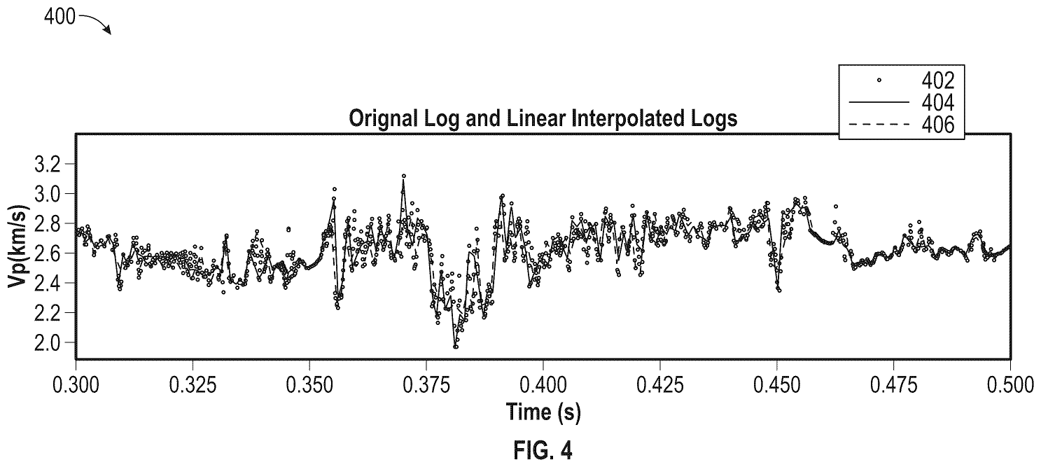

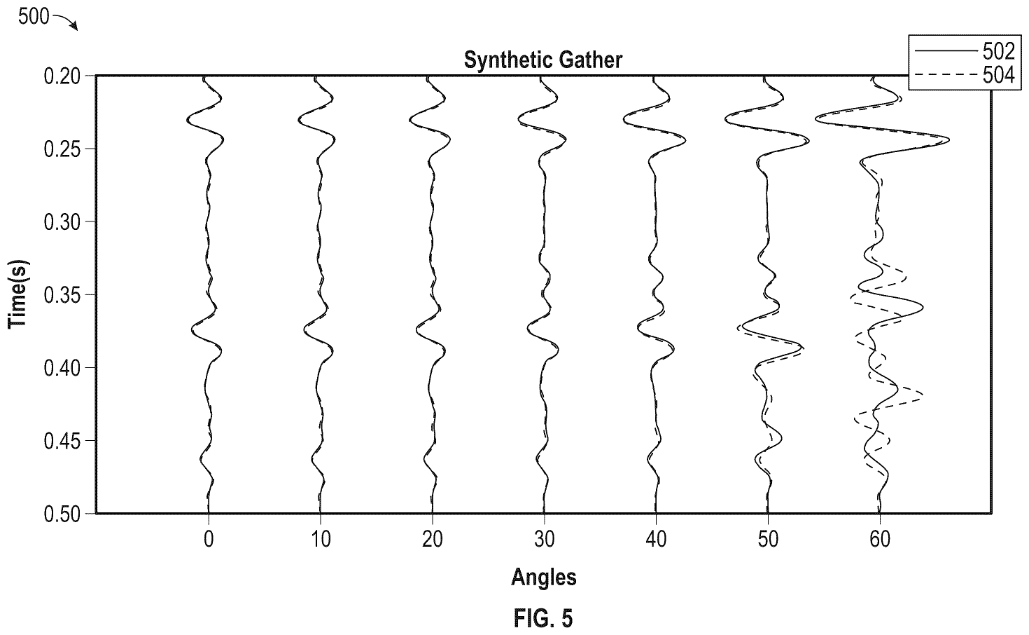

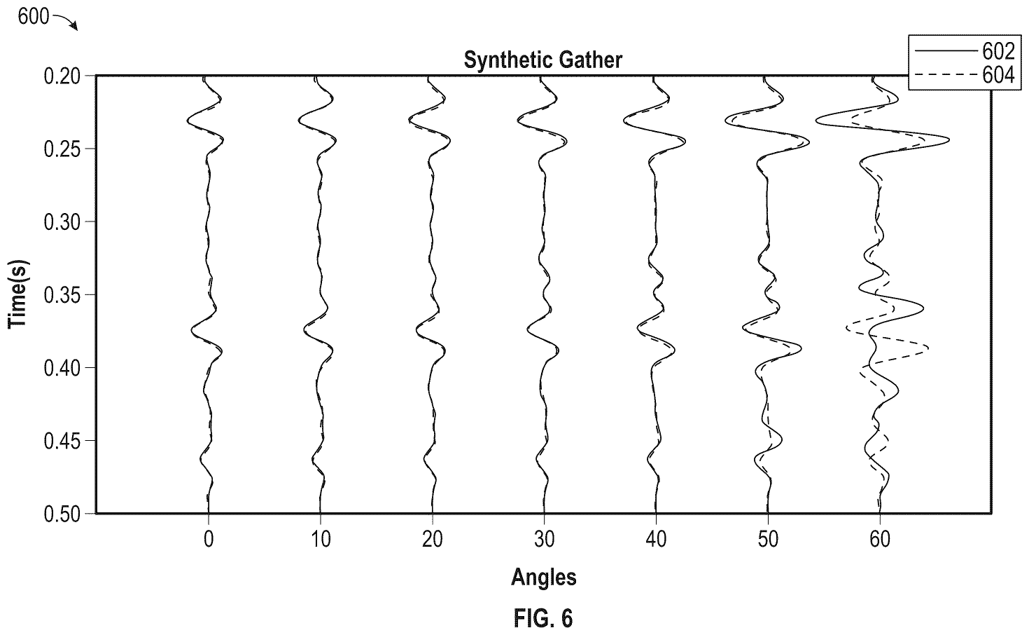

To illustrate these issues, and referring to FIGS. 4-6, graphical representations illustrating examples of synthetic seismic data generated from a well log data using conventional techniques such as the interpolation of well log data is shown. Particularly, FIG. 4 is a graphical representation illustrating a comparison between original log measurements (in irregular time and the linear interpolated logs using a fixed time interval (1 milli-second (ms) resampling). As can be observed in FIG. 4, the interpolated Vp logs are different due to the different starting windows used, which demonstrates one potential artifact of well log interpolation as will be disclosed further herein. FIGS. 5 and 6 are graphical representations illustrating examples of seismic data obtained from the same well log but generating different synthetic data. Particularly, FIG. 5 illustrates a graph plotting the synthetic data generated from a well log using different starting windows as demonstrated in FIG. 4; and FIG. 6 illustrates a graph plotting the synthetic data generated from a well log using different interpolation intervals (1 ms, and 0.1 ms). As used herein, the terms “irregular time” and “irregular intervals of time” refer to intervals of time (e.g., between reflection coefficients or other data) that are unequal such that the data points separated by the irregular intervals of time are not equidistantly spaced along a linear time scale. Conversely, as used herein, the terms “regular time” and “regular intervals of time” refer to intervals of time that are equal such that the data points separated by the regular intervals of time are equidistantly spaced along a linear time scale.

As an example of the issues pertaining to interpolation of well log (e.g., sonic log) data as outlined above, FIG. 4 particularly illustrates a graph 100 plotting the original or observed P-wave velocity (Vp) 102 obtained in irregular time directly from a well log (before resampling) in units of kilometer per second (km/s) on the y-axis, against time in seconds (s) on the x-axis. Additionally, the observed Vp 102 is overlain with a first resampled Vp 104 and a second resampled Vp 106 each generated as a 1 milli-second (ms) linear interpolation (a measure of the temporal resolution of the interpolation) of the observed Vp 102. In this example, first resampled Vp 104 was generated using a first study window while second resampled Vp 106 was generated using a second study window that was shorter than (e.g., in time duration) the first study window used to generate first resampled Vp 104. As can be observed in FIG. 4, the different study windows used to generate first resampled Vp 104 and second resampled Vp 106 result in significant differences in the resulting interpolated logs. In this example, the study window refers to the specific time or depth interval during which the well log data was analyzed in generating one or more synthetic seismic attributes. Graph 100 illustrates the sensitivity of the resulting interpolated logs with respect to the selection of the size of the study.

As another example, FIG. 5 particularly illustrates a graph 120 plotting synthetic seismic gathers 122 and 124 generated using well log data in accordance with conventional techniques such as via the linear interpolation of well log data. Synthetic seismic gathers 122 and 124 are represented as a function of time in seconds on the y-axis thereof and angles in degrees on the x-axis thereof. In this example, synthetic seismic gather 122 was generated from the well log data using a first, longer study window while synthetic seismic gather 124 was generated from the same well log data using a second, relatively shorter study window compared to synthetic seismic gather 122. In this case, the longer study window used to generate synthetic seismic gather 122 was about 0.3 ms longer than the shorter study window used to generate synthetic seismic gather 124. The study windows are selected so that they have the same ending time, with only the starting times differing. In this manner, both synthetic seismic gathers 122 and 124 have the same ending times, but their starting times differ. As can be observed in FIG. 5, synthetic seismic gather 122 is substantially different from synthetic seismic gather 124 at greater angles (50 degrees and 60 degrees) even though synthetic seismic gathers 122 and 124 are generated based on the same measured well log data (e.g., observed Vp 102 shown in FIG. 4). This illustrates that by selecting different starting windows and applying linear interpolation, some spikes may be captured while others may be missed.

Further, FIG. 6 particularly illustrates a graph 140 plotting another pair of synthetic seismic gathers 142, 144 generated from well log data using conventional techniques (e.g., including the linear interpolation of well log data) and represented as a function of time in seconds on the y-axis thereof and angles in degrees on the x-axis thereof. In this example, synthetic seismic gather 142 was generated from measured well log data using an interpolation interval of 1 ms while synthetic seismic gather 144 was generated from the same measured well log data using a second interpolation interval of 0.1 ms. As can be observed in FIG. 6, the choice in interpolation interval results in substantial differences between synthetic seismic gathers 142 and 144 at higher angles (50 degrees and 60 degrees) even though synthetic seismic gathers 142 and 144 were based on the same measured well log data.

Accordingly, embodiments disclosed herein includes a computer-implemented method for generating a synthetic seismic attribute from well logs without requiring interpolation of the well log data itself such as velocities and densities contained in the well log data. As used herein, the term “attribute” refers to measurable properties (e.g., polarity, phase, frequency) of seismic data associated with a selected subsurface region. The method includes receiving well log data (e.g., including a sonic log and a density log) obtained from a subsurface region sampled at different surface depths; determining, based on the well log data, a plurality of traveltimes of different seismic signals observed at irregular intervals of time; determining, based on the well log data and the plurality of irregular travel times, a plurality of reflection coefficients at the irregular intervals of time; convolving the plurality of irregular reflection coefficients with a source wavelet to generate a plurality of unique convolved source wavelets; and generating a synthetic seismic attribute corresponding to the subsurface region using the plurality of convolved source wavelets. Particularly, embodiments disclosed herein includes convolving the plurality of reflection coefficients with a source wavelet by scaling the source wavelet using the reflection coefficients and shifting the peaks of the resulting convolved signals to times of each irregular reflection coefficient. The convolved signals are then interpolated to provide values at regularly distributed times. Finally, all interpolated values at each regularly distributed time are combined or summed to obtain the convolved signal. In this manner, a more accurate representation of the subsurface region is generated while eliminating the undesirable practice of estimating or assuming new rock properties that may not accurately represent actual subsurface conditions.

Embodiments disclosed herein includes receiving well log data from a subsurface region sampled at different surface depths; determining a plurality of traveltimes of different seismic signals observed at irregular intervals of time from the well log data; determining, based on the well log data and traveltimes, a plurality of reflection coefficients; convolving the plurality of reflection coefficients with a source wavelet to generate a plurality of unique convolved source wavelets at the irregular intervals of time; transforming the plurality of unique convolved source wavelets at the irregular intervals of time into a plurality of interpolated convolved source wavelets located at regular intervals of time; and generating, based on the plurality of interpolated convolved source wavelets, synthetic data corresponding to the subsurface region. In this manner, a more accurate representation of the subsurface region is created from the well logs.

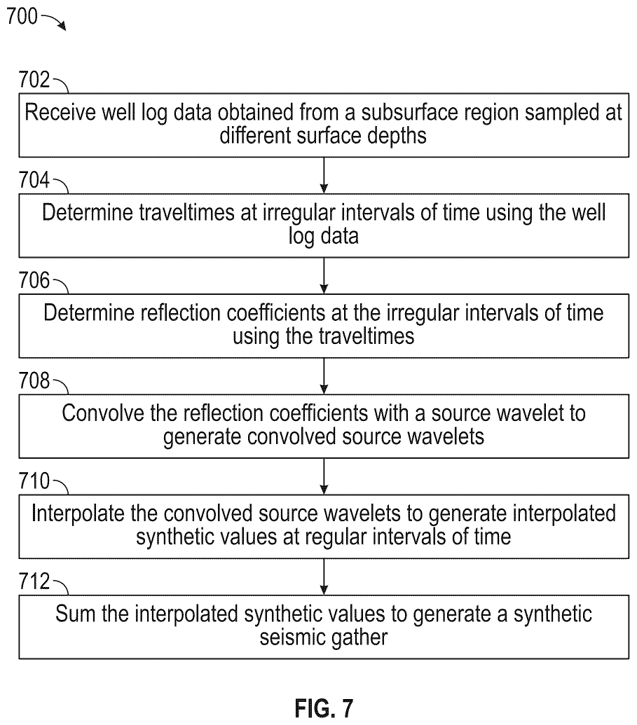

Referring now to FIG. 7, a flowchart of an exemplary method 160 for generating synthetic attributes from well logs in accordance with principles disclosed herein, is shown. This process may be performed using the computer system 60 to analyze well log data (e.g., performed as code stored on a tangible and non-transitory machine readable medium, such as the memory 66 and/or the storage 68, that when in operation causes the processor 64 to perform one or more of the steps of the method 160). Generally, method 160 begins at block 162 where well log data from a subsurface region sampled at different surface depths is received by a computer system (e.g., computer system 60). Examples of well log data may include interval transit time (Δt) of acoustic waves (p-waves and s-waves) through the formation obtained from a sonic log, velocities of the subsurface region at different surface depths, and/or density (ρ) of the subsurface region from a density log, etc. Thus, in certain embodiments, the well log data received at block 162 may include both a sonic log and a density log of a given subsurface region. In some embodiments, block 162 may include smoothening and correcting the well log data for any borehole effects (e.g., temperature changes) that may affect the results.

At block 164 of method 160, traveltimes at irregular intervals of time are determined using the well log data. The traveltimes may be determined from interval transit times captured in a sonic log of the well log data received at block 162. For example, the traveltimes determined at block 164 may be determined by combining the interval transit times with information corresponding to the geometry of the downhole logging tool used to collect the interval transit times, such as, distances between sonic transmitters and receivers of the downhole logging tool. In certain embodiments, the traveltimes determined at block 164 comprise TWTs and may be determined by doubling one-way travel times determined by combining the interval transit times with information regarding the geometry of the sonic logging tool as outlined above.

At block 166 of method 160, the computer system determines reflection coefficients at the irregular intervals of time using the traveltimes obtained at block 164 and/or other information captured in the well log data received at block 162. The reflection coefficients describe the contrast between different geological layers. The traveltimes determined at block 164 may be used to identify the times or depths at which reflections occur in the well log data, and the reflection coefficient at the interface between the layers where a reflection is identified is then determined at block 166 using log values (e.g., Vp, Vs and density) and reflection angle. In this manner, the reflection coefficients determined are unique to the reflection angles, the geological layers and structures in the subsurface region. In some embodiments, determining the reflection coefficients comprises determining the magnitude and/or phase of each reflection coefficient (i.e., the reflection coefficient may comprise real and complex reflection coefficients).

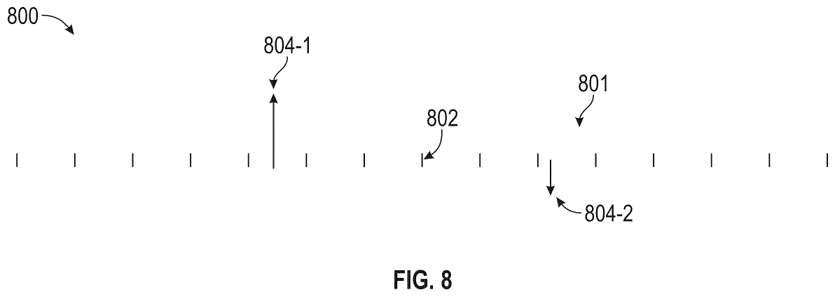

Referring briefly to FIG. 8, an exemplary diagram 180 illustrating synthetic seismic data generated using method 160 (or an analogous method) shown in FIG. 7 is shown. Particularly, FIG. 8 illustrates an exemplary temporal scale 181, which is defined by a plurality of regularly or equidistantly spaced gridpoints 182. Additionally, FIG. 8 illustrates a pair of reflection coefficients (represented by arrows 184-1 and 184-2 in FIG. 8) determined from the reflection angle and the well log data received at block 162 at different interfaces located along the subsurface region. Thus, arrows 184-1 and 184-2 represent the reflection coefficient determined from the well log data at arbitrary times (e.g., not located at any of the gridpoints 182). Additionally, the length of the arrows/reflection coefficients 184-1 and 184-2 represent the magnitude of the reflection coefficient 184-1 and 184-2 at that point and the vertical direction (e.g., extending upwards or downwards) represent the sign of the reflection coefficient 184-1 and 184-2. A positive reflection coefficient (e.g., reflection coefficient 184-1) may indicate an increase in acoustic impedance (e.g., a denser layer below a less dense layer), and a negative reflection coefficient (e.g., reflection coefficient 184-2) may indicate a decrease in acoustic impedance (e.g., a less dense layer below a denser layer).

Referring back to FIG. 7, at block 168 of method 160, reflection coefficients obtained at block 166 are convolved with a source wavelet to generate convolved source wavelets (e.g., synthetic seismic signals). For example, the reflection coefficients may be convolved or combined with a generic seismic wavelet that simulates the seismic response expected from the subsurface region when convolved with well log data collected from the subsurface region in order to generate convolved source wavelets. In some embodiments, convolving the reflection coefficients with the source wavelet comprises scaling the source wavelet with reflection coefficients (e.g., reflection coefficient 184-1 in FIG. 8) followed by shifting the peak of the scaled source wavelet to the locations of the reflection coefficients (e.g., reflection coefficients 184-1 and 184-2 shown in FIG. 8).

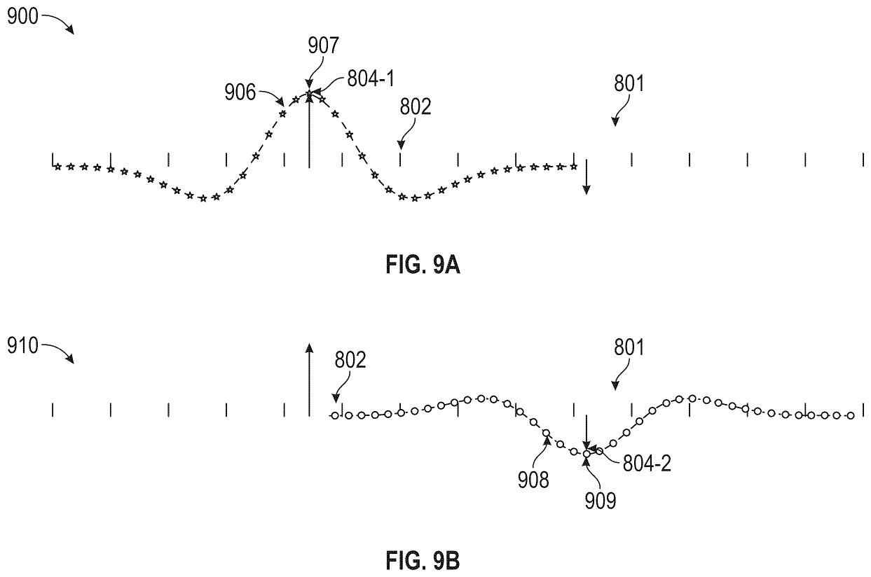

Referring briefly to FIGS. 9a and 9b, FIGS. 9a and 9b include diagrams 200 and 210, respectively, illustrating convolution of the previously discussed reflection coefficients 184-1 and 184-2 with an exemplary source wavelet. Particularly, in this example, diagram 200 shows a convolved source wavelet 206 generated by combining or convolving the original source wavelet with reflection coefficient 184-1, whereby a peak 207 of the convolved source wavelet 206 is shifted and aligned with the location of reflection coefficient 184-1. In other words, instead of interpolating well log data or reflection coefficients 184-1 and 184-2 per customary practice, convolved source wavelet 206 is aligned with the reflection coefficient 184-1 as directly observed or obtained from the well log data such as at an interface of the subsurface region. The peak 207 of the convolved source wavelet 206 is located between a pair of adjacent gridpoints 182 of temporal scale 181.

Additionally, FIG. 9b shows a separate convolved source wavelet 208 generated by combining or convolving the original source wavelet with the reflection coefficient 184-2 (negative reflection coefficient), such that the negative peak 209 of convolved source wavelet 208 is aligned with the location of reflection coefficient 184-2 at a location along temporal scale 181 that is spaced from reflection coefficient 184-1 and which again is located between (e.g., unequally or not equidistantly between) a pair of adjacent gridpoints 182. In this manner, the amplitudes of the magnitude, polarity, and location (e.g., along temporal scale 181) of the peak 207 of source wavelet 206 corresponds to the magnitude, polarity, and location of reflection coefficient 184-1 while the magnitude, polarity, and location of the peak 209 of convolved source wavelet 208 instead corresponds to the different magnitude, polarity, and location of reflection coefficient 184-2 whereby a plurality of unique convolved source wavelets 206 and 208 are generated. Additionally, convolved source wavelets 206 and 208, instead of being regularly spaced along gridpoints 182, are instead irregularly or unevenly spaced given that the peaks 207 and 209 of convolved source wavelets 206 and 208 are themselves not located at any of the regularly spaced gridpoints 182.

Referring back to FIG. 7, method 160 continues to block 170 where the convolved source wavelets from block 168 are interpolated to generate values at regular intervals of time on a grid (e.g., temporal scale 181 of FIG. 8). For instance, block 170 may include interpolating convolved source wavelets 206 and 208 shown in FIGS. 9a and 9b to thereby generate values on every gridpoint 182 of the temporal scale 181. Several interpolation methods may be used depending on the data and the desired accuracy. In some embodiments, computer system 60 may implement algorithms to interpolate the convolved source wavelet to obtain interpolated convolved source wavelets located at the output gridpoints (e.g., at regular intervals of time). In this manner, no interpolation of the well log data itself is necessary (e.g., of the interval transit times, TWTs, velocities, densities, and/or reflection coefficients thereof), eliminating the need for assumptions or estimates of new or unknown subsurface rock properties, thereby improving accuracy.

At block 172 of method 160, the interpolated convolved source wavelets at each time grid are summed to generate the value of a synthetic seismic gather. For example, at each gridpoint 182 of temporal scale 181 in FIG. 9, the interpolated values from convolved source wavelets 206 and 208 are summed together to generate values of a synthetic seismic gather.

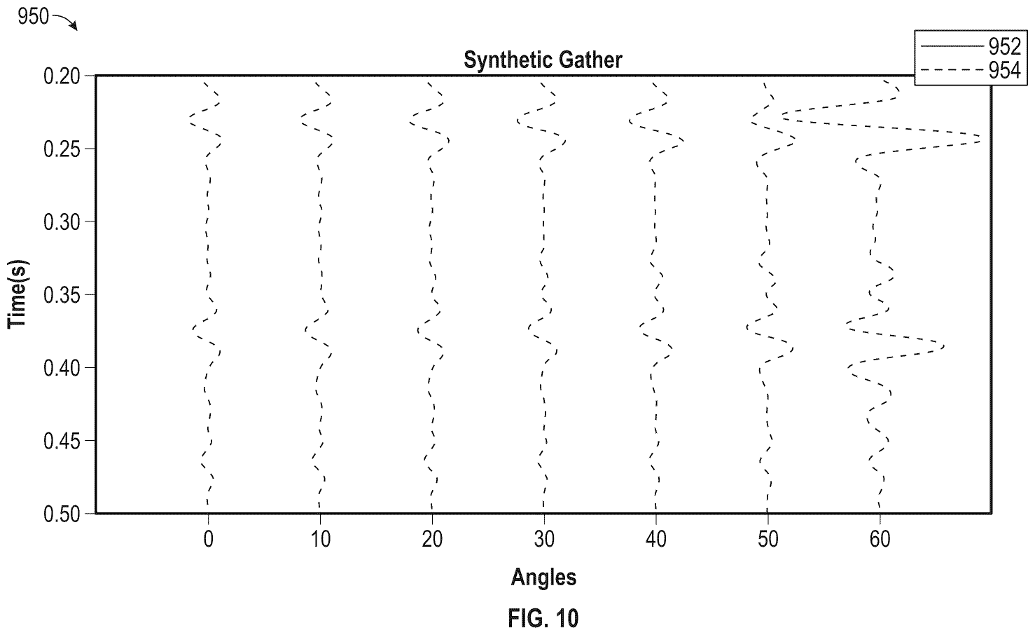

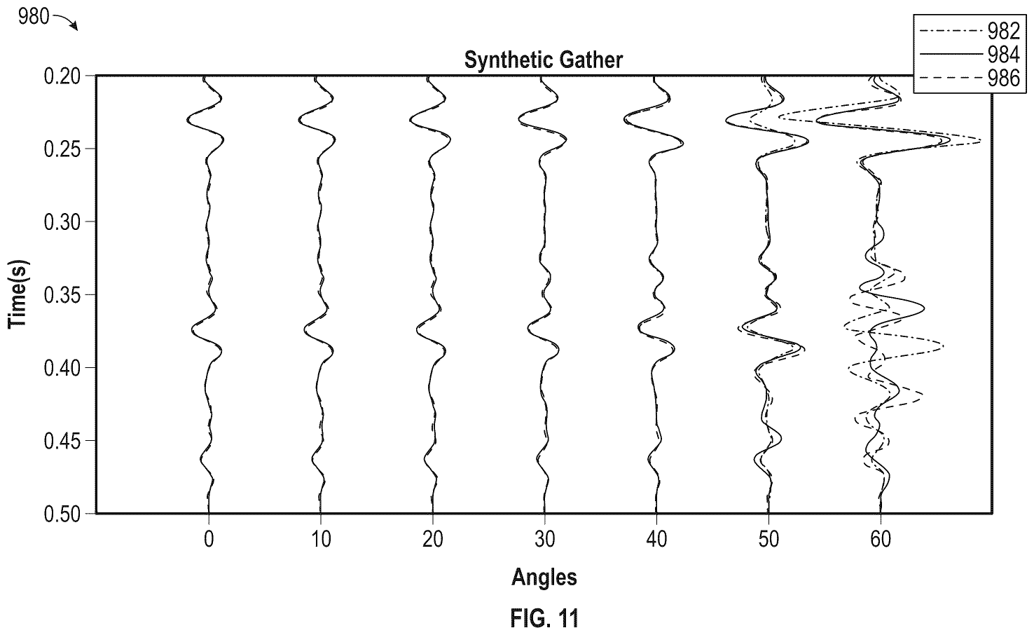

To further illustrate examples of the synthetic attributes generated using method 160, and referring to FIGS. 10 and 11, graphical representations illustrating a comparison of different synthetic gathers are shown. Particularly, FIG. 10 illustrates a graph 230 plotting a synthetic seismic gather 232 obtained from well log data using method 160 and a long study window, overlain with a separate synthetic seismic gather 234 obtained from the same well log data using method 160 but with different, relatively shorter study window. In this example, the resulting synthetic seismic gathers 232 and 234 are identical and unaffected by the different study windows, thus demonstrating the advantages of using the method 160.

Additionally, FIG. 11 particularly illustrates a graph 270 plotting a synthetic seismic gather 272 obtained from well log data using method 160, overlain with additional synthetic seismic gathers 274 and 276 obtained from the same measured well log data but using conventional methods (e.g., involving the linear interpolation of the well log data). The synthetic seismic gathers 274 and 276 were generated using different study windows with synthetic seismic gather 274 having a relatively greater study window than that of synthetic seismic gather 276. As can be observed in this example, the synthetic seismic gathers 274 and 276 are substantially different from the precise synthetic seismic gather 272.

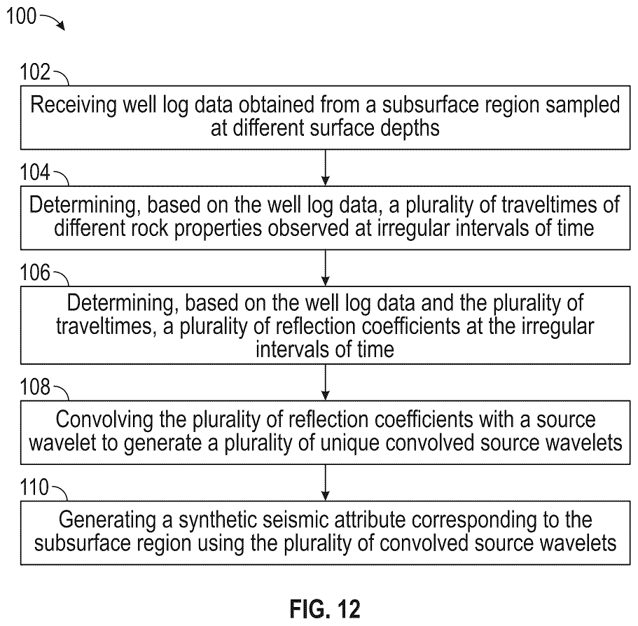

Referring now to FIG. 12 an embodiment of a method 300 for generating synthetic attributes from well logs is shown. At least some, if not all, of the steps or “blocks” of method 300 shown in FIG. 12 may be executed by the computer system 60 shown in FIG. 3, although it is to be understood that at least some of the steps of method 300 may be executed by systems other than computer system 60. Additionally, it may be understood that the generation of synthetic attributes described by method 300 may be used for a variety of purposes, including volumetric analysis and in the planning of one or more wells extending through the subsurface region. Particularly, and as further discussed below, method 300 may incorporate at least some of the features or steps of method 160 described above and shown in FIG. 7.

Beginning at block 302 method 300 includes receiving well log data obtained from a subsurface region (e.g., sampled at different surface depths). In an embodiment the well log data may include for example, interval transit time (Δt), compressional wave velocity (Vp), shear wave velocity (Vs) and density(ρ) as described above. The well log data may also include other geological and petrophysical data.

Method 300 continues at block 304 with determining, based on the well log data, a plurality of traveltimes of different rock properties observed at irregular intervals of time. In some embodiments, the processes at block 304 of method 300 may be similar to those described at block 164 of FIG. 7. The traveltimes may be determined by using the well log data to calculate the interval velocities for different depth intervals and integrating the interval velocities to create an integrated velocity model of the subsurface region. For example, the Δt obtained from a sonic log may be used to derive the interval velocity (V=1/Δt) which is then integrated to create an integrated velocity model which represents how the seismic velocities vary with depth. Well logs may be acquired in regular intervals of depth but at irregular time intervals. Thus, the integrated velocity model may be used to convert the well logs from depths to traveltimes by integrating the reciprocal of the velocity over depth to obtain the cumulative traveltime.

At block 306, method 300 continues with determining, based on the well log data and the plurality of traveltimes, a plurality of reflection coefficients at the irregular intervals of time. The processes at block 306 of method 300 may be similar to those described at block 166 of FIG. 7. The plurality of reflection coefficients is unique to the geological layers within the particular subsurface region. As previously described, the traveltimes determined at block 304 may be used to identify the times or depths at which reflections occur in the well log data. The reflection coefficient at the interface between the layers where a reflection is identified is then determined using the rock properties of the individual layers. In some embodiments, determining the plurality of reflection coefficients comprises determining the magnitude and/or phase of each of the plurality of reflection coefficient.

Method 300 continues at block 308 with convolving the plurality of reflection coefficients with a source wavelet to generate a plurality of unique convolved source wavelets. As previously described, the reflection coefficients may be convolved or combined with a generic source wavelet, which simulates the seismic response expected from the subsurface region, to generate unique convolved source wavelets. In some embodiments, convolving the reflection coefficients with the source wavelet comprises shifting, or shifting and rotating a peak of the source wavelet along an output grid/timescale along which the reflection coefficients are irregularly distributed, to a location of the reflection coefficient. As previously described, the amplitudes of the convolved source wavelet are proportional to the magnitude of the reflection coefficients and the polarity corresponds to the direction of the reflection coefficients. In this manner, the source wavelet is scaled using the magnitude of the reflection coefficients. Thus, a plurality of unique convolved source wavelet is generated and having the unique characteristics of the reflection coefficients and the shape of the source wavelet.

At block 310, method 300 continues with generating a synthetic seismic attribute associated with the subsurface region using the plurality of convolved source wavelets. The synthetic attribute may include, for example, a synthetic seismic gather. In some embodiments, the plurality of convolved source wavelets may be interpolated to generate interpolated synthetic values at regular intervals of time, which are then combined or summed to generate a synthetic seismic attribute corresponding to the subsurface region. Combining the interpolated synthetic values include stacking or summing the interpolated values of the convolved source wavelets at an output grid to generate a synthetic seismic gather.

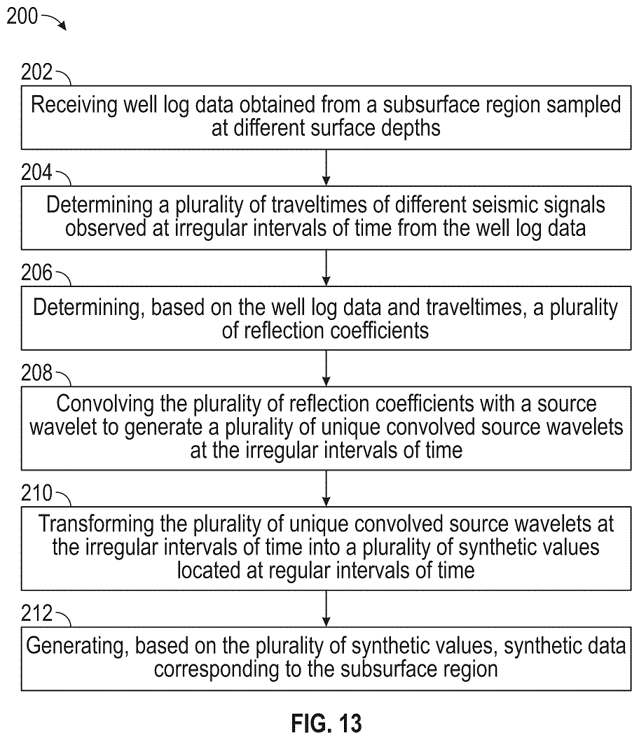

Referring now to FIG. 13, an embodiment of another method 320 for generating synthetic attributes from well logs in accordance with principles disclosed herein is shown. At least some, if not all, of the steps or “blocks” of method 320 shown in FIG. 13 may be executed by the computer system 60 shown in FIG. 3, although it is to be understood that at least some of the steps of method 320 may be executed by systems other than computer system 60. Additionally, it may be understood that the generation of synthetic attributes described by method 320 may be used for a variety of purposes, including volumetric analysis and in the planning of one or more wells extending through the subsurface region. Particularly, and as further discussed below, method 320 may incorporate at least some of the features or steps of methods 160 and 300 described above and shown in FIGS. 7 and 12, respectively.

The method 320 begins at block 322 with receiving well log data obtained from a subsurface region (e.g., sampled at different surface depths). As previously described, the well log data may include for example, interval transit time (Δt), compressional wave velocity (Vp), shear wave velocity (Vs) and density(ρ). The well log data may also include other geological and petrophysical data.

At block 324, method 320 continues with determining a plurality of traveltimes of different seismic signals observed at irregular intervals of time from the well log data. As previously described, the traveltimes may be determined by using the well log data to calculate the interval velocities for different depth intervals and integrating the interval velocities to create an integrated velocity model of the subsurface region. The integrated velocity model represents how the seismic velocities vary with depth, and is used to convert the well logs from depths to traveltimes by integrating the reciprocal of the velocity over depth to obtain the cumulative traveltime.

Method 320 continues at block 326 with determining, based on the well log data and traveltimes, a plurality of reflection coefficients. As previously described, the reflection coefficients describe the changes in rock properties between different geological layers. The traveltimes determined at block 324 may be used to identify the times or depths at which reflections occur in the well log data and the reflection coefficient at the interface between the layers where a reflection is identified is then determined using the rock properties. In this manner, the reflection coefficients determined are unique to the geological layers and structures in the subsurface region and may include the magnitude and/or phase of each reflection coefficient.

At block 328, method 320 continues with convolving the plurality of reflection coefficients with a source wavelet to generate a plurality of unique convolved source wavelets at the irregular intervals of time. As previously described, the determined reflection coefficients are unique to the geological layers within the subsurface region. In this case, the plurality of reflection coefficients may be convolved or combined with a generic source wavelet, which simulates the seismic response expected from the subsurface region, to generate unique convolved source wavelets. Convolving the reflection coefficients with the source wavelets may comprise shifting and rotating a peak of the source wavelet along an output grid/timescale along which the reflection coefficients are irregularly distributed, to a location of the reflection coefficient. In this manner, the amplitudes of the convolved source wavelet is proportional to the magnitude of the reflection coefficients and the polarity of the convolved source wavelet corresponds to the direction of the reflection coefficients. In other words, the source wavelet is scaled using the magnitude of the reflection coefficients. Thus, a plurality of unique convolved source wavelets is generated and having the unique characteristics of the reflection coefficients and the shape of the source wavelet.

Method 320 continues at block 330 with transforming the plurality of unique convolved source wavelets at the irregular intervals of time into a plurality of synthetic values located at regular intervals of time. In some embodiments, transforming the plurality of unique convolved source wavelets at the irregular intervals of time into a plurality of synthetic values located at regular intervals of time includes interpolating the convolved source wavelets at the irregular intervals of time to generate interpolated convolved source wavelets at regular intervals of time as previously described.

At block 332, method 320 continues with generating, based on the plurality of synthetic values, synthetic data associated with the subsurface region. In some embodiments, the synthetic values for each convolved source wavelet is summed to arrive at a final regularly distributed synthetic gather which may be correlated or aligned with seismic survey data to improve subsurface interpretation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for performing a function . . . ” or “step for performing a function . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A computer-implemented method for generating a synthetic seismic attribute, the method comprising:
(a) receiving well log data obtained from a subsurface region;
(b) determining, based on the well log data, a plurality of traveltimes of different rock properties observed at irregular intervals of time;
(c) determining, based on the well log data and the plurality of traveltimes, a plurality of reflection coefficients at the irregular intervals of time;
(d) convolving the plurality of reflection coefficients with a source wavelet to generate a plurality of convolved source wavelets; and
(e) generating a synthetic seismic attribute associated with the subsurface region using the plurality of convolved source wavelets.

2. The method of claim 1, further comprising:
(f) interpolating the plurality of convolved source wavelets to generate a plurality of interpolated convolved source wavelets at regular intervals of time.

3. The method of claim 2, wherein (e) comprises combining the plurality of interpolated convolved source wavelets to generate the synthetic seismic attribute.

4. The method of claim 1, wherein (c) comprises determining at least one of a magnitude or a phase of each of the plurality of reflection coefficients.

5. The method of claim 1, wherein (d) comprises scaling the source wavelet using magnitudes of the plurality of reflection coefficients to generate a plurality of scaled source wavelets.

6. The method of claim 5, wherein (d) comprises shifting a peak of the source wavelet along a timescale along which the plurality of reflection coefficients is irregularly distributed to locations of the plurality of reflection coefficients.

7. The method of claim 5, further comprising:
(f) rotating the plurality of scaled source wavelets using phases of the plurality of reflection coefficients.

8. The method of claim 1, wherein the plurality of traveltimes comprises traveltimes for each of compressional wave velocity, shear wave velocity, and density.

9. The method of claim 1, wherein the source wavelet is unrelated to the subsurface region.

10. The method of claim 1, wherein the synthetic seismic attribute comprises a synthetic seismic gather.

11. A method for generating a synthetic seismic attribute from a well log, the method comprising:
(a) receiving well log data obtained from a subsurface region;
(b) determining a plurality of traveltimes of different seismic signals observed at irregular intervals of time from the well log data;
(c) determining, based on the well log data and traveltimes, a plurality of reflection coefficients;
(d) convolving the plurality of reflection coefficients with a source wavelet to generate a plurality of convolved source wavelets at the irregular intervals of time;
(e) transforming the plurality of convolved source wavelets at the irregular intervals of time into a plurality of synthetic values located at regular intervals of time; and
(f) generating, based on the plurality of synthetic values, synthetic data associated with the subsurface region.

12. The method of claim 11, further comprising:
(g) interpolating the plurality of convolved source wavelets to generate a plurality of interpolated convolved source wavelets at regular intervals of time.

13. The method of claim 11, wherein (f) comprises adding the plurality of interpolated convolved source wavelets to an output grid.

14. The method of claim 11, wherein (c) comprises determining at least one of a magnitude or a phase of each of the plurality of reflection coefficients.

15. The method of claim 11, wherein (d) comprises scaling the source wavelet using magnitudes of the plurality of reflection coefficients to generate a plurality of scaled source wavelets.

16. The method of claim 15, further comprising:
(g) shifting a peak of the source wavelet along a timescale along which the plurality of reflection coefficients is irregularly distributed to locations of the plurality of reflection coefficients.

17. The method of claim 15, further comprising:
(g) rotating the plurality of scaled source wavelets using phases of the plurality of reflection coefficients.

18. The method of claim 11, wherein the plurality of traveltimes comprises traveltimes for each of compressional wave velocity, shear wave velocity, and density.

19. A system comprising:
one or more processors; and
a storage device coupled to the one or more processors, the storage device configured to store instructions that, when executed by the one or more processors, configure the one or more processors to:
receive well log data obtained from a subsurface region;
determine, based on the well log data, a plurality of traveltimes of different rock properties observed at irregular intervals of time;
determine, based on the well log data and the plurality of traveltimes, a plurality of reflection coefficients at the irregular intervals of time;
convolve the plurality of reflection coefficients with a source wavelet to generate a plurality of convolved source wavelets; and
generate a synthetic seismic attribute associated with the subsurface region using the plurality of convolved source wavelets.

20. The system of claim 19, wherein the instructions, when executed by the one or more processors, cause the one or more processors to interpolate the plurality of convolved source wavelets to generate a plurality of interpolated convolved source wavelets at regular intervals of time.

21. The system of claim 19, wherein the instructions, when executed by the one or more processors, cause the one or more processors to add the plurality of interpolated convolved source wavelets to an output grid.

22. The system of claim 19, wherein the reflection coefficients each comprise at least one of a magnitude or a phase.

23. The system of claim 19, wherein the instructions, when executed by the one or more processors, cause the one or more to scale the source wavelet using magnitudes of the plurality of reflection coefficients to generate a plurality of scaled source wavelets.

24. The system of claim 23, wherein the instructions, when executed by the one or more processors, cause the one or more processors to shift a peak of the source wavelet along a timescale along which the plurality of reflection coefficients is irregularly distributed to locations of the plurality of reflection coefficients.

25. The system of claim 23, wherein the instructions, when executed by the one or more processors, cause the one or more processors to rotate the plurality of scaled source wavelets using phases of the plurality of reflection coefficients.
